(19) United States
(12) Patent Application Publication
(10) Pub. No.: US 2014/0095321 A1
(43) Pub. Date: Apr. 3, 2014

(54) SYSTEM FOR ALLOCATING RESOURCES TO CHARITABLE INSTITUTIONS

(71) Applicant: Luca FRIGERIO, Rapallo GE (IT)

(72) Inventor: Luca FRIGERIO, Rapallo GE (IT)

(73) Assignee: EQUOFUND S.R.L., Rapallo GE (IT)

(21) Appl. No.: 13/629,991

(22) Filed: Sep. 28, 2012

(51) Int. Cl. G06Q 40/00; G06Q 30/02

(52) U.S. Cl. 705/14.69; 705/39

(57) ABSTRACT

A method of collecting resources and making them available to charitable institutions comprises creating a fund that allocates at least one third of its capital gain to one or more charitable institutions, making investment fund shares available to an Internet content provider, the Internet content provider joining the fund, disclosing that the Internet content provider has joined the fund and allocating at least a proportional share of the profits earned by the Internet content provider, through to the navigation of a Web navigator through contents of the Internet content provider, to the purchase of fund shares.

### FIELD OF THE INVENTION

The present invention relates to a system for allocating resources to charitable institutions, particularly a method of collecting resources and making them available to charitable institutions.

### BACKGROUND OF THE INVENTION

Dramatic changes have occurred in societies since the first industrial revolution and, especially since the end of the Second World War, the belief has become increasingly accepted that those who have greater resources should help poorer people. Nevertheless, due to life rhythms in countries having a higher concentration of resources, this moral duty is often forgotten, and is only felt in cases of natural or environmental disasters. When catastrophic events occur and are published or broadcasted by the media, there is a surge of solidarity, leading to the collection of financial resources to be allocated to the people struck by the disaster. This shows that solidarity to unfortunate people is a fact, although such solidarity is sometimes quiescent.

Charitable organizations and institutions who provide full-time assistance and resource allocation to people that live in absolute poverty and need, require continuous money flows, as their activity is based on economic resources that in most cases come from spontaneous donations of individuals or businesses.

Unfortunately, very often spontaneous donations do not have the required continuity to ensure continuous assistance or to include further people in assistance plans. As mentioned above, this is not really caused by a lack of civic sense or awareness of potential donors, but especially by the fact that potential donors do not have time (or do not want to spend time) for donation activities. This is because the fundraising activities of charitable institutions or organizations require the donor to make financial transactions (e.g. money transfers or deposits), and hence to allocate time therefor. Under particular events, e.g. natural disasters such as earthquakes, floods and the like, the availability of instruments that allow potential donors to immediately donate economic resources, such as telephone numbers to be used for sending simple sms messages for crediting a predetermined sum to a bank account after drawing it out of the telephone account of the donor, has been shown to allow large amounts of money to be collected and allocated to charitable activities.

Therefore, although many individuals are potentially willing to donate economic resources to charitable institutions or organizations, a resistance is found in the actual donation of such economic resources due to lack of time (or willingness to spend time) for these activities.

The Applicant believes that collection of resources to be allocated to charitable institutions might be advantageously improved by allowing potential donors to donate their resources in a few quick steps.

Particularly, the Applicant has faced the problem of providing a method of collecting resources and making them available to charitable institutions, that is easily and quickly used by anyone.

### SUMMARY OF THE INVENTION

The Applicant found that the above problem may be solved by a method of collecting resources and making them available to charitable institutions in which a fund makes a statutory allocation of at least a part of its capital gain to one or more charitable institutions, and in which fund shares are purchased using the economic resources made available by the persons that join the fund and that, by joining the fund, (at least potentially) increase the effect obtained by the typical actions taken to make themselves known by potential customers.

Particularly, the Applicant found that these persons may be Internet content providers and/or Web advertisers and that the economic resources used for purchasing fund shares may come from money collected by the Internet content provider for providing advertising spaces used by the Web advertiser and/or the money paid by the Web advertiser to use the advertising spaces made available by the Internet content provider.

In a first aspect, the present invention relates to a method of collecting resources and making them available to charitable institutions, comprising:

creating a fund that allocates at least one third of its capital gain to one or more charitable institutions;

making fund shares available to an Internet content provider, said Internet content provider joining the fund;

disclosing that the Internet content provider has joined the fund;

allocating at least a proportional share of the profits earned by the Internet content provider through to the navigation of a Web navigator through contents of the Internet content provider, to the purchase of fund shares.

As used herein, the term “fund” is intended to designate a financial instrument that can generate a capital gain. Examples of financial instruments that fall within the definition of fund include a bank current account, a deposit account, a post office current account, an investment fund, a fund of funds and the like. Preferably, the fund is an investment fund; therefore, reference will be expressly made hereinafter to an investment fund as a preferred example of a fund.

Preferably, the proportional share of the capital gain generated by the fund and allocated to one or more charitable institutions is 50% of the total capital gain generated by fund shares.

Preferably, the investment fund is an open fund, i.e. an investment fund in which the assets of the fund are variable (i.e. possibly increasing or decreasing daily in response to new subscriptions or claims on circulating shares).

The fact that the Internet content provider has joined the investment fund is disclosed through an Information Notice published on the Web. Such information notice may be published on the spaces owned by the Internet content provider or on other Web spaces. In the latter case, these Web spaces will contain a collection of information notes about all fund subscribers, allowing a single Web space to display all the Internet content providers that joined the fund. The information note may consist of a logo associated with the Internet content provider, or a certified list of Internet content providers, or any other means that might inform the public that a particular Internet content provider has joined the investment fund.

The Internet content provider earns its profits from an advertiser that publishes an advertisement on a Web space provided by the Internet content provider. The advertiser pays the Internet content provider a sum calculated, for instance, according to the visibility of the advertising space in the available Web space. Such visibility may be determined according to the accesses that the available Web space achieves in a predetermined time, or according to the number of accesses to the advertising space. In either case, the profits earned by the Internet content provider are generated by Web navigators, as their navigation in the spaces (contents) of the Internet content provider shall determine the value of the available advertising space. Preferably, the profits earned by the Internet content provider are generated by a Web navigator that clicks an advertising banner. Alternatively, such profits may be generated according to the statistic periodicity with which the contents published by the content provider are visited by Web navigators.

The sum allocated by the Internet content provider to the purchase of investment fund shares is a proportional share of the above mentioned profits. Preferably, such proportional share ranges from about 1% to 30%, more preferably from about 5% to 20%, most preferably about 10% of the total profits.

In addition to the proportional share generated by the capital gain of the investment fund shares, the charitable institution may be allocated shares (or part of shares) of the fund itself, as a counter-value thereof.

The investment fund shares may be held by the Internet content provider or by the Web navigator that generated (as described above) the profits allocated to the purchase of the fund shares. In the latter case, the Web navigator will decide whether, and to which extent, he/she wants to allocate the counter-value of the fund shares he/she holds to the charitable institution (in addition to the capital gain generated by the shares). In order to hold the fund shares, in addition to generating the profits for the Internet content provider (by clicking an advertising banner as described above) the Web navigator shall join the investment fund. He/she may join the investment fund by registering in a special register provided by the Internet content provider, or a register provided by the charitable institution, or a register provided by a bank that manages the investment fund. If the Web navigator joins the investment fund, the Web navigator will be able to install an application program in his/her terminal. This application program monitors the access to the contents of Internet content provider and implements a counter representative of the resources generated by the Web navigator as he/she navigates. Such counter is displayed by the application program on the navigator's terminal.

The Web content provider may be a search engine or a Web site or a Social Network. An example of a Web site is the Web site of a newspaper or another entity that can provide paid advertising spaces.

It shall be noted that a holder of investment fund shares shall receive a proportional share of the capital gain generated by the fund (net of the proportional share to be allocated to the charitable institution) and holds the fund shares. Both the fund shares and the proportional share of the received capital gain are entirely available to the shareholder. The shareholder may decide, as mentioned above, to allocate any part (or the whole) of the assets generated by the investment fund of the charitable institution, or may withhold such assets to any extent (in part or as a whole). This shall apply irrespective of whether the holder is a Web navigator or an Internet content provider.

Concerning the choice of the charitable institution for resource allocation, a list of charitable institutions that can receive the donation is created. Each charitable institution indicates which special projects will be elected to receive the collected amounts, such that the donor may select desired charitable institution's for allocation of at least one proportional share of the capital gain generated by the fund shares. The creation of lists of institutions can be designed to be managed by geolocation using applications such as electronic cartography or applications that allow geolocation of the elements being connected. Toolbars can be also provided that may facilitate acknowledgement of the share value, the real time fund value and the need indicators for all situations, that also change in real time.

In a second aspect, the present invention relates to a method of collecting resources and making them available to charitable institutions, comprising:

creating a fund that allocates at least one third of its capital gain to one or more charitable institutions;

making fund shares available to a Web advertiser, said Web advertiser joining the fund;

disclosing that the Web advertiser has joined the fund;

having the Web advertiser allocate a sum, as determined according to a consideration paid to an Internet content provider that provides a space for an advertisement by the advertiser, to the purchase of fund shares.

Like in the first aspect of the invention, the proportional share of the capital gain generated by the fund and allocated to one or more charitable institutions is preferably 50%.

Likewise, the investment fund is an open fund, i.e. an investment fund in which the assets of the fund are variable (i.e. possibly increasing or decreasing daily in response to new subscriptions or claims on circulating shares).

The fact that the Web advertiser has joined the investment fund is disclosed through an Information Notice published on the Web. Such information notice may be published on the spaces owned by the Internet content provider or on other Web spaces. In the latter case, these Web spaces will contain a collection of information notes about all fund subscribers, allowing a single Web space to display all the advertisers that joined the fund. The information note may consist of a logo associated with the advertiser, or a certified list of advertisers, or any other means that might inform the public that a particular advertiser has joined the investment fund.

The advertiser pays the Internet content provider a sum calculated, for instance, according to the visibility of the advertising space in the available Web space. Such visibility may be determined according to the accesses that the available Web space achieves in a predetermined time, or according to the number of accesses to the advertising space. In addition to the above mentioned sum paid to the Internet content provider, the advertiser allocates an additional sum (preferably determined as a percentage of the sum paid to the Internet content provider) to the purchase of the investment fund shares. Preferably, such percentage ranges from about 1% to 30%, more preferably from about 5% to 20%, most preferably about 10% of the sum paid for the advertisement.

Since the sums paid to the Internet content provider are generated by Web navigators (as their navigation in the spaces of the Internet content provider shall determine the value of the available advertising space), the Web navigator indirectly generates the sum that the advertiser allocates to the purchase of investment fund shares.

In addition to the proportional share generated by the capital gain of the investment fund shares, the charitable institution may be allocated shares (or part of shares) of the fund itself, as a counter-value thereof.

The investment fund shares may be held by the advertiser or by the Web navigator that generated (as described above) the sums allocated to the purchase of the fund shares. In the latter case, the Web navigator will decide whether, and to which extent, he/she wants to allocate the counter-value of the fund shares he/she holds to the charitable institution (in addition to the capital gain generated by the shares). In order to hold the fund shares, the Web navigator shall join the investment fund. He/she may join the investment fund by registering in a special register provided by the Internet content provider, or a register provided by the charitable institution, or a register provided by a bank that manages the investment fund. If the Web navigator joins the investment fund, the Web navigator will be able to install an application program in his/her terminal. This application program monitors the access to the contents of Internet content provider and implements a counter representative of the resources generated by the Web navigator as he/she navigates. Such counter is displayed by the application program on the navigator's terminal.

The Web content provider may be a search engine or a Web site or a Social Network. An example of a Web site is the Web site of a newspaper or another entity that can provide paid advertising spaces.

The Web advertiser may be a legal person, e.g. a business.

It shall be noted that a holder of investment fund shares shall receive a proportional share of the capital gain generated by the fund (net of the proportional share to be allocated to the charitable institution) and holds the fund shares. Both the fund shares and the proportional share of the received capital gain are entirely available to the shareholder. The shareholder may decide, as mentioned above, to allocate any part (or the whole) of the assets generated by the investment fund of the charitable institution, or may withhold such assets to any extent (in part or as a whole). This shall apply irrespective of whether the holder is a Web navigator or a Web advertiser.

Concerning the choice of the charitable institution for resource allocation, a list of charitable institutions that can receive the donation is created. Each charitable institution indicates which special projects will be elected to receive the collected amounts, such that the donor may select desired charitable institution's for allocation of at least one proportional share of the capital gain generated by the fund shares. The creation of lists of institutions can be designed to be managed by geolocation using applications such as electronic cartography or applications that allow geolocation of the elements being connected. Toolbars can be also provided that may facilitate acknowledgement of the share value, the real time fund value and the need indicators for all situations, that also change in real time.

In a third aspect, the present invention provides a method of collecting resources and making them available to charitable institutions, comprising:

creating a fund that allocates at least one third of its capital gain to one or more charitable institutions;

making fund shares available to a Web advertiser and an Internet content provider, said Web advertiser and said Internet content provider joining the fund;

allocating at least a proportional share of the profits earned by the Internet content provider and paid by said Web advertiser, and generated through to the navigation of a Web navigator through contents of the Internet content provider, to the purchase of fund shares;

having the Web advertiser allocate a sum, as determined according to a consideration paid to the Internet content provider that provides a space for an advertisement by the advertiser, to the purchase of fund shares.

This third aspect is the equivalent of the sum of the former two aspects of the invention. In other words, in the third aspect of the invention, both the advertiser and the Internet content provider will join the fund and finance it (by purchasing fund shares) as described above. Also in this case the investment fund shares may be held by the Web navigator (as described above).

In the three aspects of the invention as defined above, the fund manager may be a bank or the like, the Internet content provider or the advertiser. In a further alternative, the fund manager is none of the above mentioned persons, but a third party that owns a Web site and provides contents concerning the method of collecting resources and making them available to charitable institutions. Such third party acts as a collector for those that are actively involved in fund raising activities (i.e. the Internet content provider, the advertiser and the Web navigator). The third party's Web site also provides information concerning the Internet content providers and the advertisers that joined the fund, so that Web navigators are always informed about new Internet content providers or advertisers joining the fund. The Internet content provider, the advertiser and/or the Web navigator join the fund directly from the third party's Web site. Therefore, such Web site manages both the fund and the above mentioned register.

In the present disclosure and the annexed claims, all numbers, intervals, amounts and percentages shall be intended by way of illustration and preceded by the word “about”.

As used in the present disclosure and the claims, the term “search engine” shall be intended as an IT system that analyzes a set of data and provides an index of the available contents, after sorting them by relevance with respect to a given search key. The same term shall be also intended to designate, when confirmed by the context, the legal person that owns the search engine itself. Thus, for example,

As used in the present disclosure and the claims, the term “Web site” shall be intended to designate a set of Web pages related to each other that are hosted on a Web server and can be accessed by a navigator on request. The same term shall be also intended to designate, when confirmed by the context, the legal person that owns the Web site itself.

As used in the present disclosure and the claims, the term “Social Network” shall be intended to designate an IT structure that manages networks based on social relations over the Web. The same term shall be also intended to designate, when confirmed by the context, the legal person that owns the Web site itself.

As used in the present disclosure and claims, the term “investment fund” shall be intended to designate a financial instrument that has its own assets, divided into shares held by a plurality of members and involves cumulative management.

### BRIEF DESCRIPTION OF THE DRAWINGS

Further features and advantages of the present invention will result more clearly from the illustrative, non-limiting description of a few preferred, non-exclusive embodiments of a method of collecting resources and making them available to charitable institutions, as shown in the annexed figures, in which:

FIG. 1 is a block diagram of a first embodiment of the invention;

FIG. 2 is a block diagram of a second embodiment of the invention; and

FIG. 3 is a block diagram of a third embodiment of the invention.

### DETAILED DESCRIPTION

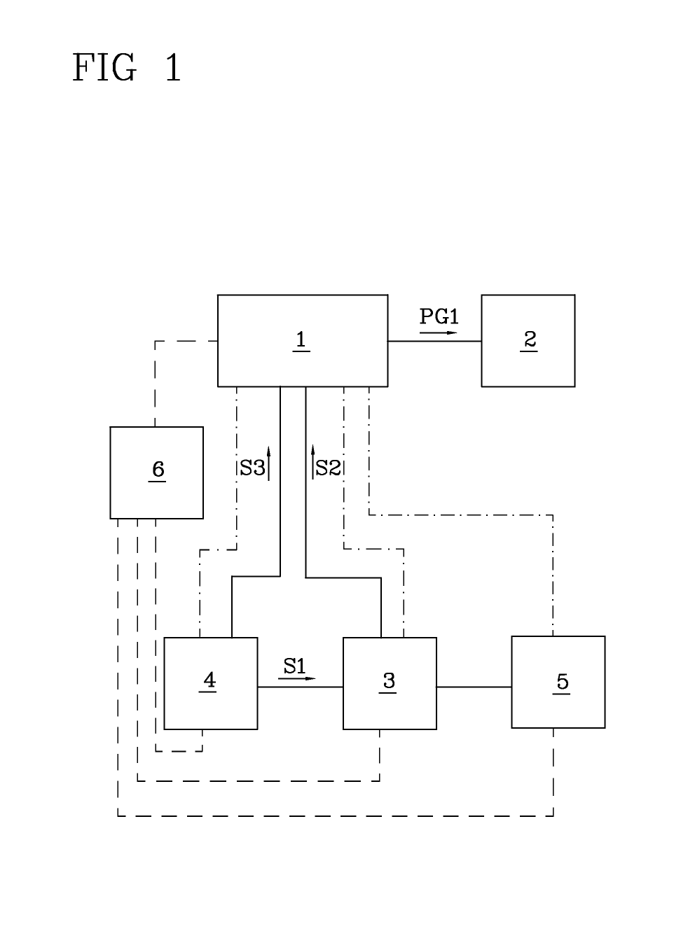

According to the embodiment of FIG. 1, an investment fund 1 is created, preferably an open investment fund, which is to make a statutory allocation of 50% of the generated capital gain PG1 to a charitable institution 2. A search engine (or a Web site) 3 joins the investment fund 1 (subscription to the fund is outlined by a chain line in FIG. 1). The search engine 3 publishes an advertisement of a web advertiser 4 on the Web. Such Web advertiser 4 pays a sum S1 to the search engine 3 for the advertisement that has been published. The sum S1 is generated, i.e. made available, to the search engine 3 (intended as the person that owns the search engine, as mentioned above) upon interaction of a Web navigator 5 with the advertising space, e.g. an advertising banner, that carries the advertisement of the Web advertiser 4. The search engine 3 allocates a sum S2, e.g. 10% of the sum S1 paid by the Web advertiser 4 to the purchase of shares of the investment fund 1.

The Web advertiser 4 also allocates a sum S3, e.g. 10% of the sum S1 paid by the search engine 3 to the purchase of shares of the investment fund 1.

The purchased shares of the investment fund may be held by the persons that paid the sums for purchasing them, i.e. the Web advertiser 4 and the search engine 3, or by the Web navigator.

In the latter case, the Web navigator 5 shall join the investment fund 1. He/she may do so by registering in a special register provided by the search engine 3, in a special register provided by the fund itself (or the bank that manages it) or in a special register provided by the Web advertiser 4. Alternatively, the above mentioned special register is provided by a third party that owns a Web site. Such third party acts as a collector for those that are actively involved in fund raising activities (i.e. the Internet content provider, the advertiser and the Web navigator). The third party's Web site also provides information concerning the Internet content providers and the advertisers that joined the fund, so that Web navigators are always informed about new Internet content providers or advertisers joining the fund. The Internet content provider, the advertiser and/or the Web navigator join the fund directly from the third party's Web site.

The registration in the special register (irrespective of the person that provided it), allows the Web navigator 5 to be recognized as a “fair-trade navigator” and assures that he/she holds the shares of the investment fund 1, purchased by navigating through the search engine 3.

It shall be noted that the Web navigator 5 may acknowledge, regardless of whether he/she is a “fair-trade navigator” or not, that the search engine 3 joined the investment fund 1 and will allocate the sum S2 to the purchase of fund shares 1. For this purpose, the search engine 3 uses its Web spaces to publish or anyway display an information note stating that it joined the investment fund 1. Such information note may be, for instance, a logo and/or a link to a Web page with the details of the initiative. Instead of or in addition to the above, the third party's Web site will use its Web spaces to publish or anyway display an information note concerning all the search engines 3 that joined the investment fund 1 and provide resources for financing the fund.

Likewise, the Web navigator 5 will be able to acknowledge, regardless of whether he/she is a “fair-trade navigator” or not, that the Web advertiser 4 has joined the investment fund 1. For this purpose, the search engine 3 uses its Web spaces to publish or anyway display information stating that the Web advertiser joined the investment fund 1. Such information may be, for instance, a logo and/or a link to a Web page with the details of the initiative. Instead of or in addition to the above, the third party's Web site will use its Web spaces to publish or anyway display an information note concerning all the Web advertisers 4 that joined the investment fund 1 and provide resources for financing the fund.

It shall be noted that, as stated above, the search engine 3, the Web advertiser 4 and the Web navigator 5 form a “fair trade” network, i.e. a group of persons that have the common goal of making resources available to charitable institutions. If a third party is present, as mentioned above, it will act as a collector for the “fair trade” network, and publish, as mentioned above, information concerning the persons that joined the fund.

The charitable institution that will receive a part of the capital gain generated PG1 by the investment fund 1 is selected as follows.

A database 6 of the charitable institutions that can receive allocated resources is created and made available on the Web (e.g. on the third party's Web site). This database 6 contains the name of each charitable institution and a list of projects that each charitable institution is managing. Preferably, the database 6 is displayed in map form, with the various running projects (funded by each charitable institution) displayed in the geographical place where each project is conducted. Those that hold the shares of the investment fund 1 that generated the capital gain PG1 select (broken line in FIG. 1) the project that they want to be funded, in the bank 6. The charitable institution that manages that project will be associated to such selection. The fund manager 1 will be informed of the selection and will allocate the proportional share of the capital gain PG1 to the charitable institution associated with the selected project.

Those who hold shares of the investment fund 1 may also elect to allocate additional resources to the selected charitable institution, besides the proportional share of the capital gain generated by the fund shares they hold.

Such additional resources may be an additional proportional share of the capital gain generated by the fund shares and/or the whole capital gain generated by the fund shares and/or part of the fund shares held and/or all the fund shares held.

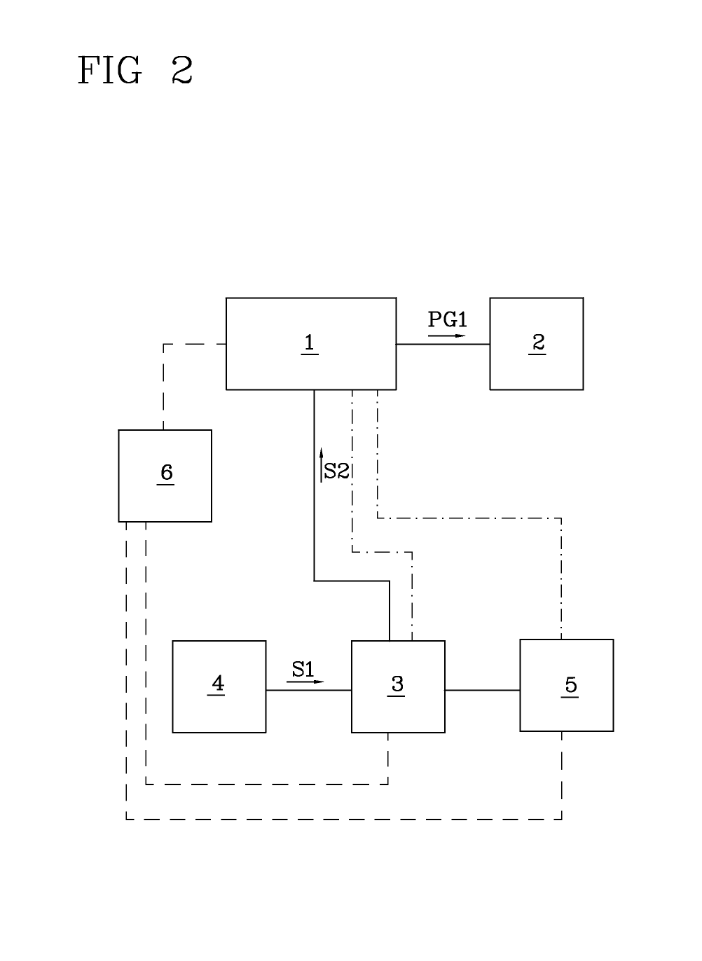

The method of FIG. 2 differs from that described above in that the Web advertiser 4 does not join the investment fund 1. The method of FIG. 2 is identical to that described above except that the Web advertiser 4 does not make the sum S3 available for the purchase of shares of the investment fund 1.

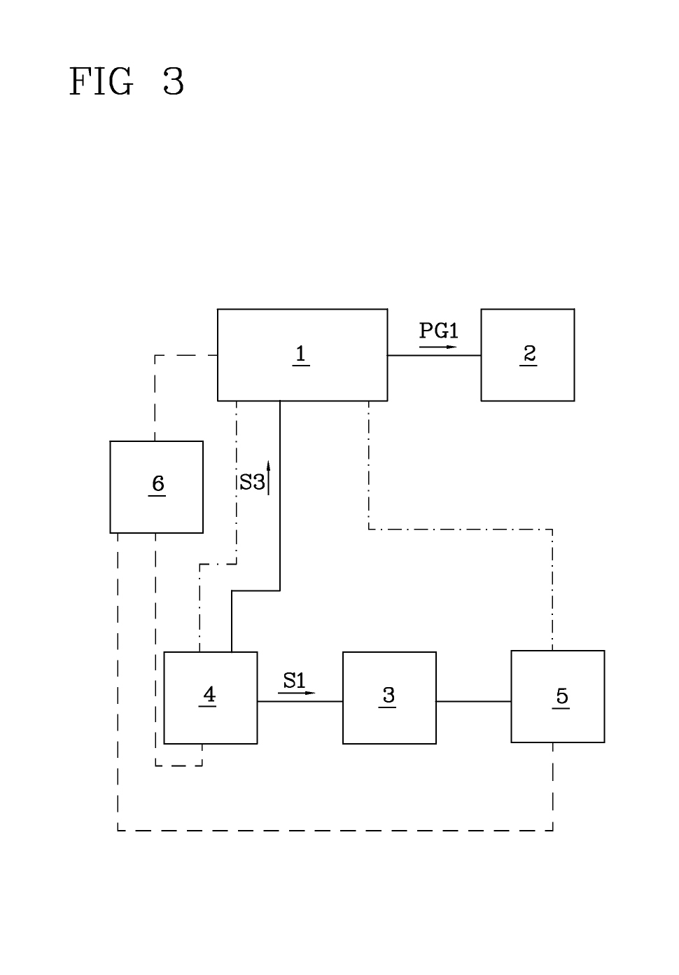

Likewise, the method of FIG. 3 differs from that described above in that the search engine 3 does not join the investment fund 1. The method of FIG. 3 is identical to that described above with reference to FIG. 1, except that the Web advertiser 3 does not make the sum S2 available for the purchase of shares of the investment fund 1.

1. A method for collecting resources and making them available to charitable institutions, comprising:
creating a fund that allocates at least one third of its capital gain to one or more charitable institutions;
making fund shares available to an Internet content provider, said Internet content provider joining the fund;
disclosing that the Internet content provider has joined the fund;
allocating at least a proportional share of the profits earned by the Internet content provider, through to the navigation of a Web navigator through contents of the Internet content provider, to the purchase of fund shares.

2. A method as claimed in claim 1, wherein the Internet content provider collects its receipts from an advertiser that publishes an advertisement on a Web content space provided by the Internet content provider.

3. A method as claimed in claim 1, wherein the profits earned by the Internet content provider are generated by a Web navigator that clicks an advertising banner published on the contents of the Internet content provider.

4. A method as claimed in claim 1, wherein the profits earned by the Internet content provider are generated by the statistic periodicity with which the contents published by the content provider are visited by Web navigators.

5. A method as claimed in claim 1, which further comprises collecting at least one proportional share of the purchased fund shares and allocate the counter-value thereof to one or more charitable institutions.

6. A method as claimed in claim 1, wherein the Internet content provider selects which institution's are to receive the allocated capital gains generated by the purchased fund shares.

7. A method as claimed in claim 1, wherein the contents of the Internet content provider are a search engine.

8. A method as claimed in claim 1, wherein the contents of the Internet content provider are a Web site.

9. A method as claimed in claim 1, wherein the fund shares purchased with the proportional share of the profits earned by the Internet content provider are held by the Web navigator that generated such profits; said Web navigator having joined the fund beforehand.

10. A method for collecting resources and making them available to charitable institutions, comprising:
creating a fund that allocates at least one third of its capital gain to one or more charitable institutions;
making fund shares available to a Web advertiser, said Web advertiser joining the fund;
disclosing that the Web advertiser has joined the fund;
having the Web advertiser allocate a sum, as determined according to a consideration paid to an Internet content provider that provides a space for an advertisement by the advertiser, to the purchase of fund shares.

11. A method as claimed in claim 10, which further comprises collecting at least one proportional share of the purchased fund shares and allocate the counter-value thereof to one or more charitable institutions.

12. A method as claimed in claim 10, wherein the Web advertiser selects which institution's are to receive the allocated capital gains generated by the purchased fund shares.

13. A method as claimed in claim 10, wherein the fund shares purchased with the sum allocated by the advertiser are held by a Web navigator that opened the advertisement; said Web navigator having joined the fund beforehand.

14. A method for collecting resources and making them available to charitable institutions, comprising:
creating a fund that allocates at least one third of its capital gain to one or more charitable institutions;
making fund shares available to a Web advertiser and an Internet content provider, said Web advertiser and said Internet content provider joining the fund;
allocating at least a proportional share of the profits earned by the Internet content provider and paid by said Web advertiser, and generated through to the navigation of a Web navigator through contents of the Internet content provider, to the purchase of fund shares;
having the Web advertiser allocate a sum, as determined according to a consideration paid to the Internet content provider that provides a space for an advertisement by the advertiser, to the purchase of fund shares.

15. A method as claimed in claim 14, wherein subscription of the fund is obtained by registration with a Web site owned by a third party, other than said Internet content provider, said advertiser and said Web navigator; said Web site publishing information about Internet content providers and Web advertisers that joined the fund.
